(19) United States
(12) Patent Application Publication
(10) Pub. No.: US 2025/0330757 A1
(43) Pub. Date: Oct. 23, 2025

(54) METHOD FOR OPERATING A HEARING DEVICE SYSTEM

(71) Applicant: Sivantos Pte. Ltd., Singapore (SG)

(72) Inventor: Julius KRIEG, Zuerich (CH)

(73) Assignee: Sivantos Pte. Ltd., Singapore (SG)

(21) Appl. No.: 19/184,550

(22) Filed: Apr. 21, 2025

(30) Foreign Application Priority Data
Apr. 19, 2024 (DE) 10 2024 203 680.3

(51) Int. Cl. H04R 25/00; G10L 15/08

(52) U.S. Cl. CPC H04R 25/505; G10L 15/083; H04R 2225/41

(57) ABSTRACT

A method for operating a hearing device system having a hearing device, in which an audio signal is sensed. Speech is recognized in the audio signal, and a prediction for future speech is created on the basis of the recognized speech. A setting for a signal processing unit is determined for the prediction. An additional audio signal is sensed, and the additional audio signal is further processed via the signal processing unit, wherein the setting is used. The invention additionally relates to a hearing device system.

This nonprovisional application claims priority under 35 U.S.C. § 119 (a) to German Patent Application No. 10 2024 203 680.3, which was filed in Germany on Apr. 19, 2024, and which is herein incorporated by reference.

### BACKGROUND OF THE INVENTION

### Field of the Invention

The invention relates to a method for operating a hearing device system and to a hearing device system.

### Description of the Background Art

People who suffer from a reduced hearing capacity customarily use a hearing aid. Here, an ambient sound is converted into an electrical (audio/sound) signal, usually via a microphone, which is to say an electromechanical sound transducer, so that an electrical signal is created. The electrical signals are processed via a signal processing unit and introduced into the person's auditory canal via an additional electromechanical transducer in the form of an earpiece. The signal processing unit is a part of a control unit of the hearing aid in this case. Generally, a processing of the sound signal additionally takes place, for which purpose a signal processor of the signal processing unit is customarily used. In this case, the amplification is tailored to any hearing loss the hearing aid wearer may have.

The mode of amplification and the mode of otherwise processing the sound signals is effected here via a setting of the signal processing unit, in particular. A customized, predefined setting is used according to the situation in which the user of the hearing aid, which is a hearing device, finds himself. Generally, a setting that is intended for a conversation of the user with one other person is also present here. In this mode, background noises are reduced, for which purpose certain frequencies are damped, for example. Harmonics, for example, are also reduced. However, it is also possible here that frequencies that are necessary for distinguishing certain phones, which is to say sounds, from other sounds are likewise excessively damped so that these sounds are not distinguishable for the user. Consequently, a speech intelligibility is reduced. In this context, sound (phone) is understood hereinbelow to mean the pronunciation of a phoneme, where this can be a consonant as well as a vowel here.

### SUMMARY OF THE INVENTION

It is therefore an object of the invention is provide an especially suitable method for operating a hearing device system and an especially suitable hearing device system, wherein, in particular, a speech intelligibility is improved for a user.

In an example, the method serves to operate a hearing device system that has a hearing device. The hearing device in this case can be intended and configured to be worn on the human body. In other words, in its intended state the hearing device is worn by a wearer, who is also referred to as a user, hearing aid user, hearing aid wearer, or consumer. Preferably, the hearing device includes a retaining apparatus, by which means the device can be secured to the human body.

For example, the hearing device can be an earphone or includes an earphone. This is designed as, for example, a so-called in-ear, on-ear, or over-ear earphone. For example, the earphone serves to reproduce information and/or music, and/or the earphone serves the purpose of noise suppression and is a so-called noise canceling earphone. Especially preferably, the hearing device is a hearing aid, however. The hearing aid serves to assist a person suffering a diminished hearing capacity. In other words, the hearing aid is a medical device, which compensates for, e.g., a partial hearing loss. The hearing aid is, for example, a “receiver-in-canal” hearing aid (RIC; external earpiece hearing aid), an in-the-ear hearing aid, such as an ITE hearing aid, an “in-the-canal” hearing aid (ITC), or a “completely-in-the-canal” hearing aid (CIC). Alternatively, the hearing aid is a behind-the-ear hearing aid (BTE hearing aid), which is worn behind the outer ear. When the hearing device is a hearing aid, it is intended and equipped to be located behind the associated ear or inside an auditory canal of the ear, for example.

The hearing device can include a microphone, which serves to sense sound. In particular, an ambient sound, or at least a part thereof, is sensed via the microphone during operation. The microphone is, in particular, an electromechanical sound transducer. The microphone has, for example, only a single microphone unit or multiple microphone units that interact with one another. Each of the microphone units expediently has a diaphragm, which is set in vibration by sound waves, wherein the vibrations are converted into an electrical signal via an appropriate recording device, such as, e.g., a magnet that is moved in a coil. Consequently it is possible to sense, via the respective microphone unit, an audio signal that is based on the sound striking the microphone unit. The microphone units are designed to be unidirectional, in particular. Expediently, the microphone is arranged at least partially inside a housing of the hearing device and consequently is at least partially protected.

The hearing device can include a signal processing unit, which preferably is coupled to the microphone. The signal processing unit constitutes, for example, a control unit of the hearing device or expediently is a part thereof. The signal processing unit in this case serves, in particular, to further process or at least analyze the audio signal(s) created via the microphone. In particular, a processing of the audio signal is accomplished via the signal processing unit so that an output signal is created that is changed in comparison with the audio signal. In particular, an amplification of certain frequencies of the audio signal is carried out via the signal processing unit in this case, wherein preferably an adjustment takes place to any hearing loss the hearing aid wearer may have. For example, the signal processing unit has multiple analog components. Expediently, the signal processing unit or at least the control unit includes a digital sound processor (DSP). Expediently, the (sound) processor is designed to be programmable.

The hearing device can have an earpiece that serves, in particular, to output the respective output signal. The output signal in this case is, in particular, an electrical signal. Expediently, the earpiece is coupled to the signal processing unit, in particular connected thereto by signal transmitter/receiver. Depending on the design of the hearing device, in the intended state the output device is typically arranged at least partially inside an auditory canal of the wearer of the hearing device, which is to say a person, or is at least acoustically connected thereto.

The hearing device can be wearable/portable and can be intended and configured to be inserted at least partially into an auditory canal. Especially preferably, the hearing device includes an energy storage device, by which means a power supply is provided. Preferably, the hearing device has a communication device that includes a radio system, in particular. For example, the audio signal is received, and thus provided, via the communication device during operation.

The method provides that the audio signal can be sensed. This is accomplished via, e.g., the possible microphone or the possible communication device. For example, the audio signal is created via the hearing device, in particular on the basis of sound, or the audio signal is already present as a fully electrical signal when it is sensed.

In another step, speech is recognized in the audio signal. In particular, a check is made here as to whether a speech signal is present in the audio signal. A speech recognition algorithm, in particular, is used for this purpose, preferably a so-called “speech-to-text” algorithm. In other words, the audio signal is analyzed for the presence of speech, and the information contained in the audio signal is sensed. In this process, not only is the presence of speech detected, but the information provided via the speech is also recognized. After the recognition, the speech is expediently present in a form that can be processed with a computer, for example as text. The speech represents, e.g., a part of a word, a word, a part of a sentence, or a sentence, or at least includes these.

A prediction for future speech can be created on the basis of the detected speech. In other words, an assumption is expediently made as to which word part, word, sentence part, or sentence will subsequently be uttered by a speaker who corresponds to the recognized speech, which is to say, in particular, is its originator. If the recognized speech is a word part, then the future speech is, e.g., the remaining part of the word. For example, a Markov model or an “autocomplete” algorithm is used to create the prediction. An already-existing algorithm that, for example, is used within the framework of word processing programs is used in the creation of the prediction for the future speech.

A setting for the signal processing unit can be determined for the predictions. The setting is predefined, for example, or is newly created on the basis of current circumstances. An additional audio signal is sensed, wherein the sensing of the additional audio signal expediently occurs after the sensing of the audio signal and these suitably follow one another in time. The additional audio signal is differentiated from the audio signal in that, in particular, the initial recognition of speech, on which basis the prediction is created for the future speech expected in the additional audio signal, takes place only in the audio signal.

The additional audio signal is subsequently further processed via the signal processing unit, wherein the setting is used. Consequently, if the future speech is actually present in the additional audio signal, then this speech is further processed in accordance with the setting that was adjusted for the prediction, so that speech intelligibility is improved. Expediently, the setting is selected such that if the future speech is actually present, its intelligibility is improved. In other words, if the additional speech present in the additional audio signal corresponds to the prediction for the future speech, then it is expediently contained more clearly after the processing on account of the setting.

On account of the method, the signal processing unit can therefore be adjusted as a function of the speech present in the audio signal so that the probability is increased that additional speech occurring in the additional audio signal, if present, is reproduced in an improved manner, at least when it corresponds to the prediction of the future speech. In other words, phones, which is to say sounds, occurring in the additional audio signal are therefore reproduced in an improved manner, wherein the setting is adjusted for the sounds likely to occur in each case. It therefore is not necessary to choose a setting in which all sounds are reproduced well, albeit more poorly than in the case of an explicit adjustment to one or a few sounds, or in other words to choose a compromise. This also avoids adjusting the signal processing unit in such a manner that the great majority of sounds are reproduced in an improved manner, but speech intelligibility is relatively poor for certain, individual sounds.

Expediently, the additional audio signal can be output, in particular via the possible earpiece, after the further processing. Consequently, the further processed, additional audio signal is intelligible for the user. Alternatively, a recording/storing of the further processed audio signal takes place, for instance. For example, the audio signal is not further processed via the signal processing unit. Alternatively thereto, the audio signal is also further processed via the signal processing unit, wherein for this purpose, in particular, a different setting is used to which the signal processing unit was set until the determination of the setting.

Suitably, the method can be carried out essentially continuously so that (additional) speech is also recognized in the additional audio signal, on the basis of which a (new) prediction for future speech is created. A (new) setting is determined for this, on which basis the signal processing unit is then set. Consequently, continuous determination of the setting and adjustment of the signal processing unit takes place, for which reason speech intelligibility is improved even for a speech passage of relatively long duration. In particular, the prediction takes place for individual sounds or for a relatively small number of sounds, for example between 2-10 sounds. Consequently, the setting of the signal processing unit, in particular, is determined repeatedly during a sentence of a speaker whom the user of the hearing device is listening to.

For example, the signal processing unit can include a filter that is operated in accordance with the setting. Consequently, a processing effort is reduced. Alternatively thereto, the signal processing unit includes, e.g., a neural network, in particular a DNN (“deep neural network”). Speech intelligibility is further improved owing to the use of the neural network.

Expediently, a Fourier transform, in particular a “short-time Fourier transform” (STFT) can be carried out during the further processing via the signal processing unit. A time window between 2 ms and 20 ms is expediently used for this purpose. A non-rectangular window function, e.g., Hann window, Hamming window, Blackman window functions, Gaussian window, Turkey window, is used in the Fourier transform, for example. Alternatively or in combination therewith, a smoothing of the transitions between partially overlapping windows with time takes place. Alternatively or in combination, a phoneme-dependent setting of the filter strength takes place, for example, phoneme-dependent ratio of the amplifications of the filtered and the unfiltered additional audio signals that are combined. Alternatively or in combination, the width of the window function is chosen in a phoneme-dependent manner. Alternatively or in combination, a phoneme-dependent choice of the degree of overlap of the window functions takes place.

For example, an NNMF (non-negative matrix factorization) can be carried out via the signal processing unit. This is described in U.S. Pat. No. 8,015,003 B2, for example. The method is also described in Raj, B., Singh, R., & Virtanen, T. (2011), “Phoneme-Dependent NMF for Speech Enhancement in Monaural Mixtures,” in Speech Science and Technology for Real Life, Conference Proceedings of Interspeech 2011, 27-31 Aug. 2011, Florence, Italy (pp. 1217-1220) (Annual Conference of the International Speech Communication Association INTERSPEECH), which is incorporated herein by reference. Expediently, an NNMF with different phoneme basis vectors is carried out, wherein the results are adjusted on the basis of weighted amplification in accordance with the prediction, in particular the probability, of which phoneme corresponds to the phone present in the additional audio signal (the prediction reliability can vary) and/or phoneme type. Preferably, the Fourier transform is employed in the NNMF. Alternatively thereto, for example, the neural network is used that has been trained on the basis of simulations for different sounds, for example. In particular, background noises are also contained in the simulations here, and the training takes place such that, for example, speech intelligibility is improved, or the relative level of the background noises is reduced. A corresponding method is described in US 2023 016987 A1.

For example, the prediction includes only a single possibility for the future speech. If there should be an uncertainty and/or an ambiguity here, the most probable possibility is used, and the setting is determined on the basis thereof. Alternatively thereto, the prediction includes multiple possibilities for future speech. In other words, the prediction is therefore implemented in the manner of a vector that includes the different possibilities for the future speech. In particular, the different possibilities, namely how the, e.g., word fragment and/or sentence fragment provided via the speech can be completed, arise on the basis of the recognized speech in this case. One of the possibilities is associated with each completion here. Expediently, the number of possibilities is limited in this case, and preferably is less than 10 or 5. Consequently, an effort is reduced. Expediently, one instance apiece of the settings is determined for each of the possibilities. Consequently, a corresponding instance is determined for each of the possibilities, and therefore for each possibly occurring sound, wherein some or all of the instances are identical, for example. However, it is also possible that they differ, in particular if the sounds described via the respective possibilities differ relatively strongly. On account of the multiple possibilities as well as the respective associated instances, a relatively flexible response to the actual additional speech uttered by the speaker is improved and, in particular, a relatively rapid adjustment of the setting is made possible. Thus, for example, a switching between the instances of the settings is possible when, e.g., the instance employed does not result in an improved speech intelligibility.

For example, the instance for which the associated possibility has the highest probability can be selected initially, and used for the signal processing unit. Especially preferably, however, additional speech is recognized initially in the additional audio signal, for which purpose the same algorithm for recognition is used, in particular, that is also employed to recognize the speech in the audio signal. Consequently, an effort is reduced. Suitably, the additional speech is compared with the possibilities, which is to say the prediction for the future speech, and one of the instances is selected as a function of the comparison. In particular, in this case the instance is selected that corresponds to the possibility that matches the additional speech or at least a portion of the additional speech. In particular, only a portion of the possibilities, in particular the beginning of the possibilities, is compared with the additional speech during the comparison, and the additional audio signal is only analyzed at the beginning for the presence of the additional speech. After the selection of the instance, no additional comparison is then carried out any longer, in particular, so that an effort is reduced. In other words, there is no initial wait until the complete additional audio signal has been sensed before the comparison takes place, but this instead takes place while the sensing is still occurring, and the additional audio signal also continues to be sensed after completion of the comparison, and further processed with the correspondingly set signal processing unit. For example, the sensed additional audio signal is output essentially unchanged until the completion of the comparison, or is further processed via a setting that is present until that point. Alternatively, only after the comparison is the additional audio signal output from the beginning. It is therefore ensured on the basis of the selection of the instance as a function of the comparison that the instance corresponding to the additional speech is employed, so that the speech intelligibility is improved.

For example, the setting may be determined solely as a function of the prediction. Especially preferably, however, additional parameters/variables are also taken into account so that a speech intelligibility is further improved. In particular, the determination of the setting furthermore takes place as a function of a current environment. Especially preferably, a first value characterizing speech is determined, and is taken into account in the determination of the setting. In particular, the speaker, which is to say the originator of the speech, is characterized via the first value in this process. Consequently, an association of the speech with a certain speaker, which is to say with the identity of the speaker, is carried out. In particular, different settings or different modes of creating the settings are associated with different identities here. Alternatively or in combination therewith, a dialect of the speech, voice characteristics such as the resonance behavior, or an accent of the speaker, such as an atypical emphasis on certain syllables, are taken into account, for example. The respective setting, in particular, is then determined on the basis thereof so that the speech intelligibility is then further improved for the user of the hearing device.

A second value characterizing the hearing capacity of the user of the hearing device can be determined and taken into account in the determination of the setting. If the user suffers from a hearing loss, this is taken into account such that the additional speech that is further processed in accordance with the method is relatively intelligible. For this purpose, specific frequencies for which the user's hearing capacity is diminished, in particular, are amplified disproportionately and/or a compression is carried out, which is to say specific frequencies are shifted.

Preferably, both the first value and the second value can be taken into account in the determination of the setting so that a speech intelligibility is improved for the user in question. Alternatively thereto, only one of these values is used. For example, during the determination of the setting, said setting is picked from a multiplicity of possible settings, and, in particular, each instance is one selected in each case from a multiplicity of already-existing instances, which reduces an effort. Alternatively thereto, the setting, in particular each of the instances, is always recalculated currently. Consequently, a relatively precise adjustment to the one current situation/future speech is possible.

For example, only the setting can be used essentially immediately, as soon as it is known, for the further processing. In other words, an abrupt switchover of the signal processing unit to the setting takes place. Consequently, the speech intelligibility of the additional audio signal is increased relatively early. Alternatively thereto, the operation of the signal processing unit is adjusted continuously to the setting. If, for example, the signal processing unit was operated until the determination of the setting on the basis of a different setting, the individual parameters of the other setting are adjusted continuously, which is to say gradually, to the corresponding parameters of the (newly determined) setting. This is accomplished steadily or in multiple jumps or steps, for example. Consequently, there is no abrupt switchover, for which reason a comfort is improved for the user. Alternatively or in combination with the adjusting of the individual parameters, the additional audio signal is initially further processed via the other setting and also with the setting by the signal processing unit, and the two audio signals provided in this way are mixed with one another, which is to say superimposed. In this process, the degree of superposition is, in particular, changed continuously, for example over a specific time period, preferably linearly. The time period is suitably less than 10 seconds, 5 seconds, or 2 seconds, and preferably greater than 100 ms. Consequently, the switchover is likewise not directly perceptible for the user, wherein an effort during adjustment is reduced.

For example, the prediction can be created and the associated setting determined for each speech recognized in the audio signal. This is always accomplished in the same manner, in particular. Alternatively thereto, a determination is made as to whether the recognized speech is a desired signal or background noise. In this case, it is background noise, for example, when the speech is only relatively poorly intelligible/soft, or comes from a spatial region that is not preferred. The setting is expediently determined as a function of the classification, which is to say whether the detected speech is a desired signal or background noise. In this case the setting is, in particular, adjusted in such a manner that the intelligibility is reduced when the recognized speech is classified as background noise, so that the additional speech in the further processed additional audio signal is not perceptible by the user as speech, for example. Consequently, the user is not bothered thereby. If, however, it is a desired signal, then the setting is such that the intelligibility is improved, in particular. Consequently, the user can better follow the additional speech contained in the further processed additional audio signal.

For example, the method can be carried out solely via the hearing device, and the hearing device system includes solely the hearing device. Alternatively thereto, the hearing device also includes a server that is, in particular, spaced apart from the hearing device. In this case the server is at least partially connected to the hearing device by signal transmitter/receiver during the method, for example directly or via an additional device, such as a smartphone, for example. In this case a Bluetooth connection is suitably established between the hearing device and the smartphone, and the smartphone is connected to the server by WLAN/mobile telephony and the Internet. The audio signal and the additional audio signal are sensed via the hearing device, and the prediction is created via the server. Consequently, requirements on the hardware of the hearing device and a power demand for the hearing device are reduced, wherein the predictions are nevertheless created in a relatively short period of time and the hearing device can be designed to be relatively compact. A changing of the algorithm on the basis of which the prediction is created is also simplified in this way, for example. Expediently, the server is associated with a multiplicity of hearing devices so that common resources can continue to be used with different hearing device systems, which reduces manufacturing costs. In particular, the setting is additionally determined, for example created, via the server. Consequently, this step, in which a relatively high computing effort occurs, is also carried out via the server, thus further reducing the hardware resources required for the hearing device. Consequently, the length of time between the sensing of the audio signal and the further processing of the additional audio signal with the setting is shortened, for which reason the speech intelligibility is increased relatively swiftly. It is also possible in this way to use a relatively short audio signal whose duration is, in particular, between 2 ms and 20 ms so that the prediction is created and the setting determined anew multiple times during a sentence, for example. Consequently, a speech intelligibility is relatively high. For example, the speech is likewise recognized via the server. Consequently, relatively little hardware is required for the hearing device. Especially preferably, however, the speech in the audio signal and the possible additional speech in the additional audio signal are recognized via the hearing device. As a result, a quantity of data to be transmitted to the server is reduced, which further shortens the time between the sensing of the audio signal and the using of the setting.

The hearing device system can have a hearing device that is designed, in particular, as a hearing aid. The hearing device includes a signal processing unit. The hearing device system is operated in accordance with the method, in which an audio signal is sensed. Speech is recognized in the audio signal, and a prediction for future speech is created on the basis of the recognized speech. For the prediction, a setting for the signal processing unit is determined. An additional audio signal is sensed, and the additional audio signal is further processed via the signal processing unit, wherein the setting is used. Suitably, the method is carried out least partially via the signal processing unit, which is suitable, and in particular intended and configured, for this purpose. Expediently, the hearing device system furthermore includes a server that is coupled to the hearing device by signal transmitter/receiver, at least when carrying out the method.

The improvements and advantages described in connection with the method should also be applied correspondingly to the hearing device system and vice versa.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 schematically shows a hearing device system; and

FIG. 2 shows a method for operating the hearing device system.

### DETAILED DESCRIPTION

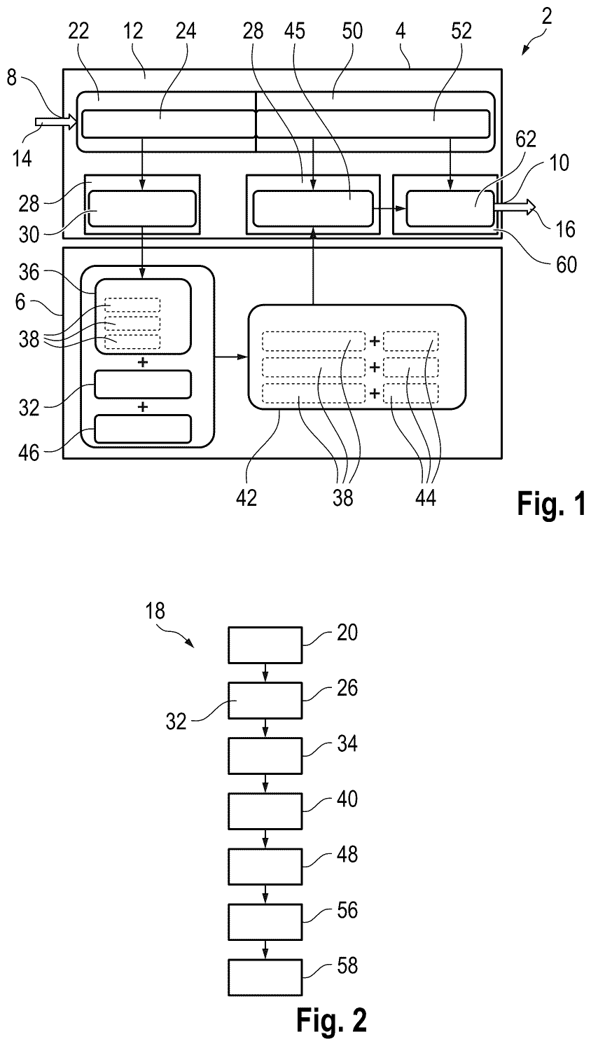

In FIG. 1, a schematically simplified view of a hearing device system 2 is shown, which includes a hearing device 4 in the form of a hearing aid and a server 6 that is spaced apart therefrom. These can be connected to one another by signal transmitter/receiver via a smartphone so that an exchange of data between them is made possible. The hearing device 4 has a microphone 8 and an earpiece 10, between which a signal processing unit 12 is connected. Consequently, it is possible to sense ambient sound 14 via the microphone 8 and to output, via the earpiece 10, sound 16 that is based on the ambient sound 14.

In FIG. 2, a method 18 for operating the hearing device system 2 is shown. In a first step 20, an audio signal 22 is sensed. In this process, the audio signal 22 is created via the microphone 8 as a function of the ambient sound 14, and is essentially the electrical representation of the ambient sound 14. Contained in the audio signal 22 here are components 24 that have been produced by a speaker, which is to say speech components.

In a following second step 24, speech 30 is recognized in the audio signal 22 via a speech recognition algorithm 28, for example a “speech-to-text” algorithm. In other words, components 24 present in the audio signal 22 are identified and converted into text via the speech recognition algorithm 28.

Furthermore, a first value 32 characterizing the speech 30 is determined in the second step 26. The identity of the speaker, which is to say the originator of the speech 30 and thus also of the components 24, is employed here as first value 30. In addition, the speech 30 is classified, namely as to whether it is a desired signal or background noise. In this case, it is a desired signal when the user (wearer) of the hearing device 4 is conversing with the speaker. In contrast, it is background noise when the part of the ambient sound 14 corresponding to the components 44 comes from a spatial region that is, e.g., behind the user or should not be presented to the user, or only to a minor degree, on account of a directionality of the hearing device 4 that is set.

In a following third step 34, the first value 32 and the recognized speech 30 are transmitted to the server 6, where a prediction 36 for future speech is created on the basis of the speech 30. In other words, a determination is made as to what the speaker is likely to say next. If, for example, the speech 30 breaks off in a sentence or word, the estimated remainder of the sentence/word is employed as the prediction 36. A Markov model or an “autocomplete” algorithm will is used to create the prediction. If there are different alternatives here, each is used as one of the possibilities 38 of the prediction 36. Since the prediction 36, which is to say all the possibilities 38, are created via the server 6, a hardware requirement for the hearing device 4 is reduced.

In a fourth step 40, a setting 42 for the prediction 36 is determined, likewise via the server 6. In this process, one instance 44 apiece of the setting 42 is determined for each of the possibilities 38. The instances 44 in this case include specifications for how certain frequencies should be amplified/damped, wherein this is dependent on the respective possibility 38. In this way, the frequencies that should be amplified/damped differ for the possibilities 38, information that is stored via the instances 44. The first value 32 is taken into account, which is to say the identity of the speaker and their speech characteristics, in the determination of the setting 42, namely the instances.

Furthermore, a second value 46 characterizing the hearing capacity of the user of the hearing device 4, which is stored in a memory of the server 6, is taken into account in the determination of the setting 42, namely all the instances 44. If, for example, the user can perceive a certain frequency relatively poorly, this frequency is amplified disproportionately for all the instances 44, in particular independently of the respective possibility 38. In the determination of the setting 42, the categorization of the speech 30, which is to say whether it is a desired signal or background noise, is also taken into account in this case. In summary, the first value 32 and the second value 46 are taken into account in the determination of the setting 42.

In a following fifth step 48, the setting 42 is transmitted to the hearing aid 4 via which an additional audio signal 50 that directly follows the audio signal 22 is sensed. Consequently, the audio signal 22 and the additional audio signal 50 are sensed via the hearing device 4, whereas the prediction 36 and the setting 42 are created via the server 6 of the hearing device system 2. In this case the hearing device 4 and the server 6 are connected to one another by signal transmitter/receiver so that an exchange of corresponding data between them is made possible. Additional components 52, which together with the components 24 yield a complete sentence/statement, are present in the additional audio signal 50. Additional speech 54 is recognized in the additional audio signal 50 via the speech recognition algorithm 28.

In a sixth step 56, the recognized additional speech 54 is compared with all the possibilities 38, and the one that matches the additional speech 54 or is similar thereto is chosen. The instance 44 of the setting 42 corresponding to this possibility 38 is picked, and in a following seventh step 58 a signal processor 60 of the signal processing unit 12 is set to this instance 44, and the additional audio signal 50 is further processed therewith so that a further processed additional audio signal 62 is created.

Operation of the signal processing unit 12, namely of the signal processor 60, is adjusted continuously to the setting 42 insofar as this setting differs from the (other) setting used hitherto. For this purpose, the damping is increased successively over a time window of 100 ms for the frequencies that are now more strongly damped as compared to the other setting, whereas the amplification is increased continuously over the time window for the frequencies that are now to be amplified disproportionately. Consequently, no abrupt switchover in the operation of the signal processor 60 takes place. The further processed, additional audio signal 62 is output via the earpiece 10 and hence presented to the user.

On the basis of the setting 42 that is used, the speech intelligibility is improved here when the speech 30 is a desired signal. In contrast, when speech 30 is background noise, the speech intelligibility is reduced on the basis of the setting 42 that is then determined accordingly. In summary, the instances 44 of the setting 42 are created in such a manner that the speech intelligibility in the output of the further processed additional audio signal 62 is improved or worsened, respectively, depending on whether it is a desired signal or background noise.

In particular, the signal processor 60 has an appropriate filter or a neural network that has been trained appropriately. Alternatively thereto, an NNMF (non-negative matrix factorization), in which the basis vectors or the weighting of the basis vectors are chosen in accordance with the setting 42, is accomplished via the signal processor 60. After conclusion of the seventh step 58, the additional speech 54, in particular, is considered as (new) speech 30, and the third step 34 is carried out anew. Consequently, the setting 42 is determined repeatedly, for example during a sentence or a conversation of the user with the speaker, so that different settings 42 are determined and used in each case for the individual sounds delivered by the speaker.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a hearing device system comprising a hearing device, the method comprising:
sensing an audio signal;
recognizing speech in the audio signal;
creating a prediction for future speech based on the recognized speech;
determining a setting for a signal processing unit for the prediction;
sensing an additional audio signal; and
further processing the additional audio signal via the signal processing unit, wherein the setting is used.

2. The method according to claim 1, wherein the prediction includes multiple possibilities for the future speech, and wherein an instance apiece of the setting is determined for each of the possibilities.

3. The method according to claim 2, wherein additional speech is recognized in the additional audio signal, wherein one of the instances is selected and used for the signal processing unit as a function of a comparison of the additional speech with the possibilities.

4. The method according to claim 1, wherein a first value characterizing the speech is determined and is taken into account in the determination of the setting.

5. The method according to claim 1, wherein a second value characterizing the hearing capacity of the user of the hearing device is determined and taken into account in the determination of the setting.

6. The method according to claim 1, wherein the operation of the signal processing unit is continuously adjusted to the setting.

7. The method according to claim 1, wherein a determination is made as to whether the speech is a desired signal or background noise, and wherein the setting is determined as a function hereof.

8. The method according to claim 1, wherein the audio signal and the additional audio signal are sensed via the hearing device, and wherein the prediction is created via a server of the hearing device system that is connected by a signal transmitter/receiver to the hearing device.

9. A hearing device system comprising a hearing device that is operated according to the method of claim 1.
